(19) United States
(12) Patent Application Publication
(10) Pub. No.: US 2013/0158964 A1
(43) Pub. Date: Jun. 20, 2013

(54) REUSABLE WORKFLOWS

(71) Applicants: Gabriel J. Hall, (US); Mauricio F. Ordonez, (US); Darren S. Miller, (US); Jun Yong Kim, Seoul (KR); Chong Youn Choe, Seoul (KR); Dae Il Kim, Seoul (KR); Hyong Guk Kim, Seoul (KR)

(72) Inventors: Gabriel J. Hall, (US); Mauricio F. Ordonez, (US); Darren S. Miller, (US); Jun Yong Kim, Seoul (KR); Chong Youn Choe, Seoul (KR); Dae Il Kim, Seoul (KR); Hyong Guk Kim, Seoul (KR)

(73) Assignee: Microsoft Corporation, Redmond, WA (US)

(21) Appl. No.: 13/325,403

(22) Filed: Dec. 14, 2011

(51) Int. Cl. G06G 7/48

(52) U.S. Cl. 703/3

(57) ABSTRACT

A method for providing a new workflow that reuses an existing workflow includes displaying one or more collections of existing workflows available for selection; receiving a selection of one of the one or more existing workflow collections; displaying one or more existing workflows associated with the selected existing workflow collection; receiving a selection of one of the existing workflows in the selected existing workflow collection; receiving a selection of a variable in the selected existing workflow to be used in the new workflow; and storing the new workflow such that, when executed, the new workflow utilizes the selected variable from the existing workflow.

### BACKGROUND

Workflows are computer-implemented representations of real world processes that exist within organizations. Workflows assist users with collaboration on documents and management of project tasks by implementing specific business processes on documents and items. Workflows also assist organizations with adherence to consistent business processes, and improve organizational efficiency and productivity by managing the tasks and steps involved in specific business processes.

### SUMMARY OF THE INVENTION

An embodiment includes a method for providing reusable workflows. Method includes displaying one or more collections of existing workflows available for selection; receiving a selection of one of the one or more existing workflow collections; displaying one or more existing workflows associated with the selected existing workflow collection; receiving a selection of one of the existing workflows in the selected existing workflow collection; receiving a selection of a variable in the selected existing workflow to be used in the new workflow; and storing the new workflow such that, when executed, the new workflow utilizes the selected variable from the existing workflow.

In another embodiment, a system for providing reusable workflows is disclosed. System includes a shared application platform storing one or more collections of existing workflows; a workflow design tool coupled to the shared application platform, the workflow design tool configured to: display one or more collections of existing workflows available for selection; receive a selection of one of the one or more existing workflow collections; display one or more existing workflows associated with the selected existing workflow collection; receive a selection of one of the existing workflows in the selected existing workflow collection; receive a selection of a variable in the selected existing workflow to be used in the new workflow; and store the new workflow such that, when executed, the new workflow utilizes the selected variable from the existing workflow.

A computer-readable medium including executable instructions that, when executed by a processor, provide one or more reusable workflows is disclosed. The computer-readable medium includes instructions executable by the processor for receiving an action input from a user to begin a new workflow design; displaying one or more collections of existing workflows available for selection; displaying one or more existing workflows associated with the selected workflow collection; receiving a selection of an existing workflow, the existing workflow selected from the displayed one or more existing workflows; and guiding a user to customize one or more parameters of the selected existing workflow for use in a new workflow.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

Referring now to the drawings in which like reference numbers represent corresponding parts throughout:

FIG. 1 illustrates the high-level architecture of a system for providing reusable workflows according to one embodiment;

FIGS. 2a-2b are a flowcharts of a method for creating one or more new workflows using one or more existing workflow components according to an embodiment;

FIGS. 3A-3D illustrate an initial user interface for starting a new workflow using one or more existing workflow components according to one embodiment of the disclosure;

FIG. 4 illustrates an initial user interface for starting a new workflow using one or more existing workflow components according to one embodiment of the disclosure;

FIG. 5 illustrates a workflow list user interface for selecting a workflow and a workflow list;

FIG. 6 illustrates a user interface for customizing existing workflow parameters for use by the new workflow according to one embodiment;

FIG. 7 illustrates a parameter details user interface according to one embodiment;

FIG. 8 illustrates a set item user interface for a “list” type of existing workflow according to one embodiment;

FIG. 9 illustrates a set item user interface for a “list” type of existing workflow according to one embodiment;

FIG. 10 illustrates an example lookup interface for selecting one or more workflow items;

FIG. 11 a process diagram illustrating the runtime of a new workflow according to one embodiment;

FIG. 12 illustrates workflow process monitoring according to one embodiment;

FIGS. 13A-13B illustrate a property pain according to one embodiment;

FIG. 14 is a simplified block diagram of a distributed computing system in which embodiments of the present invention may be practiced.

### DETAILED DESCRIPTION

Embodiments of the present invention provide reusable workflows, one or more components of which may be used by a new workflow.

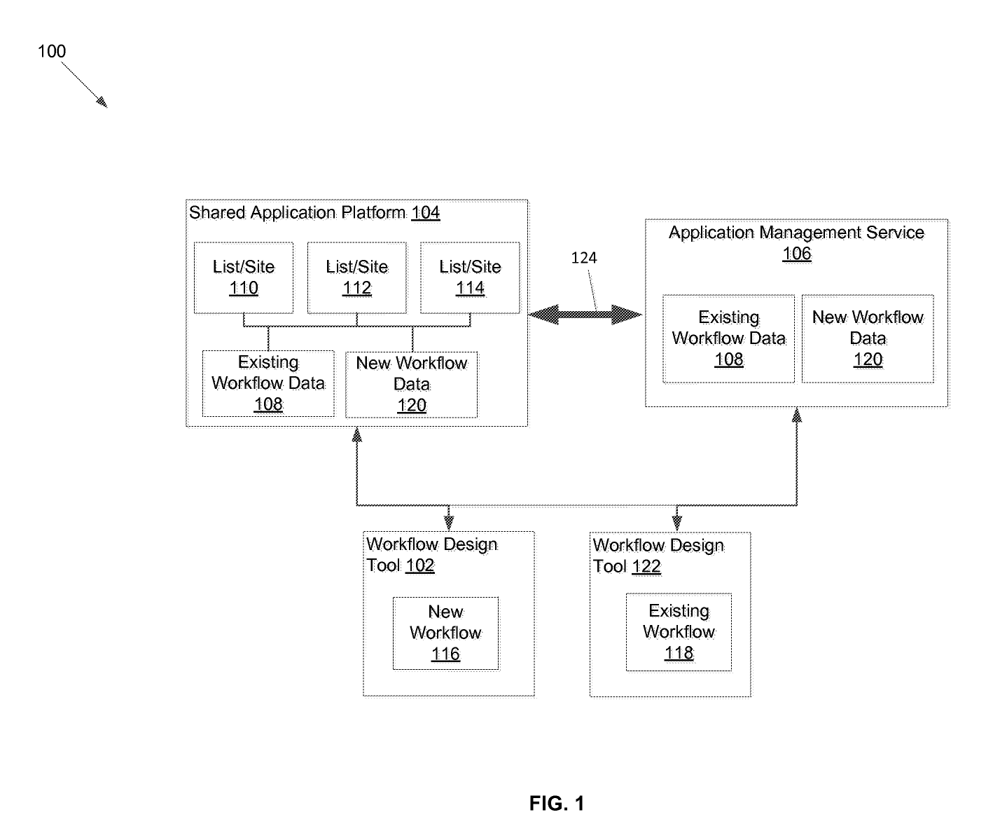

FIG. 1 illustrates the high level architecture of a system 100 for providing reusable workflows according to one embodiment. System may include one or more workflow design tools 102, 122, a shared application platform 104, and an application management service 106 operably coupled to at least the shared application platform 104. Workflow design tools 102, 122 may be, for example, versions of a web or shared services application designer such as Microsoft® SharePoint® Designer. Shared application platform 104 may be, for example, Microsoft® SharePoint® or a Microsoft® SharePoint® server. Application management service 106 may be a cloud services provider such as Microsoft® AppFabric. At a high level, a workflow design tool 102 is configured to generate a new workflow 116 using one or more components of an existing workflow 118 that may have been created using a separate workflow design tool 122. Workflow components may include any parameters of the existing workflow 118.

New workflow design may be accomplished by initiating a series of existing workflow data requests and sending the data requests to the shared application platform 104. Data requests may include a request for collection of workflow lists 110, 112, 114 stored in the shared application platform 104, a request for a specified workflow list of the collection of workflow lists 110, 112, 114, a request for one or more parameters associated with a selected existing workflow 118, and, optionally, a request for one or more items associated with the existing workflow 118. As used herein, a workflow item may be an item on which a workflow may run (e.g., a document, spreadsheet, etc.) Requests are sent to the shared application platform 104 (or optionally to the application management service 106). Workflow design tool 102 receives back existing workflow data 108 in the form of one or more parameters, variable values and/or workflow conditions of the existing workflow 118 from the shared application platform 104 and inputs the received data 108 as input parameters and variables to be used for creating the new workflow 116.

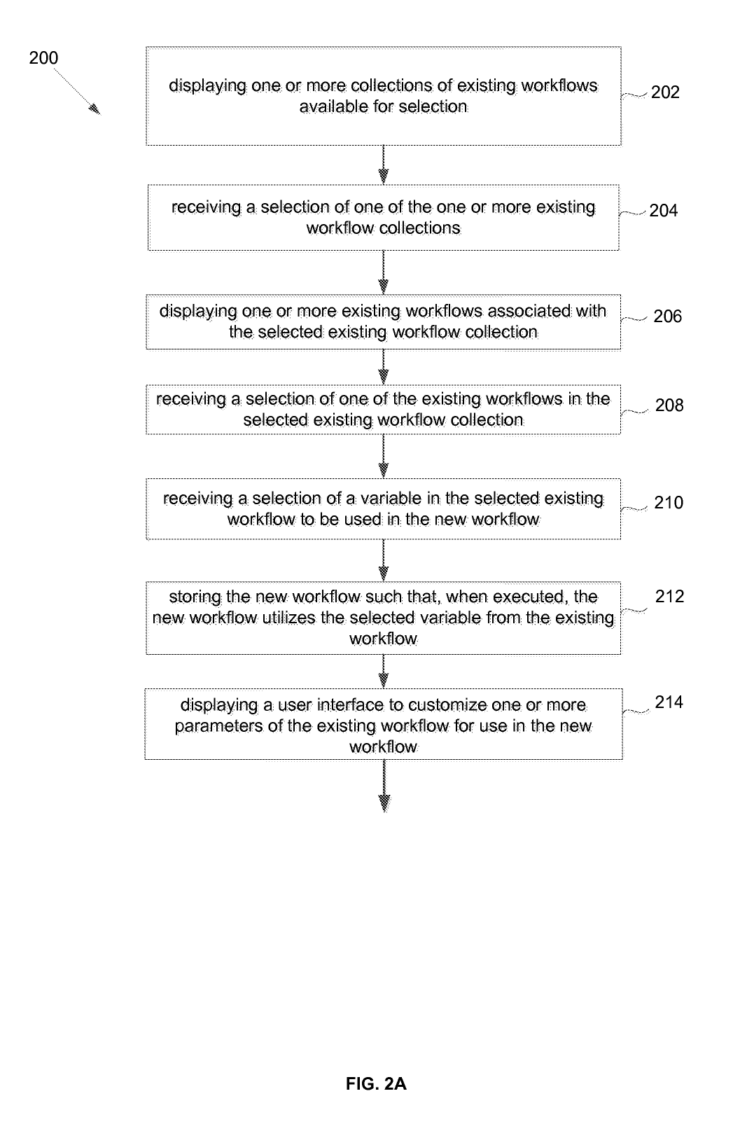

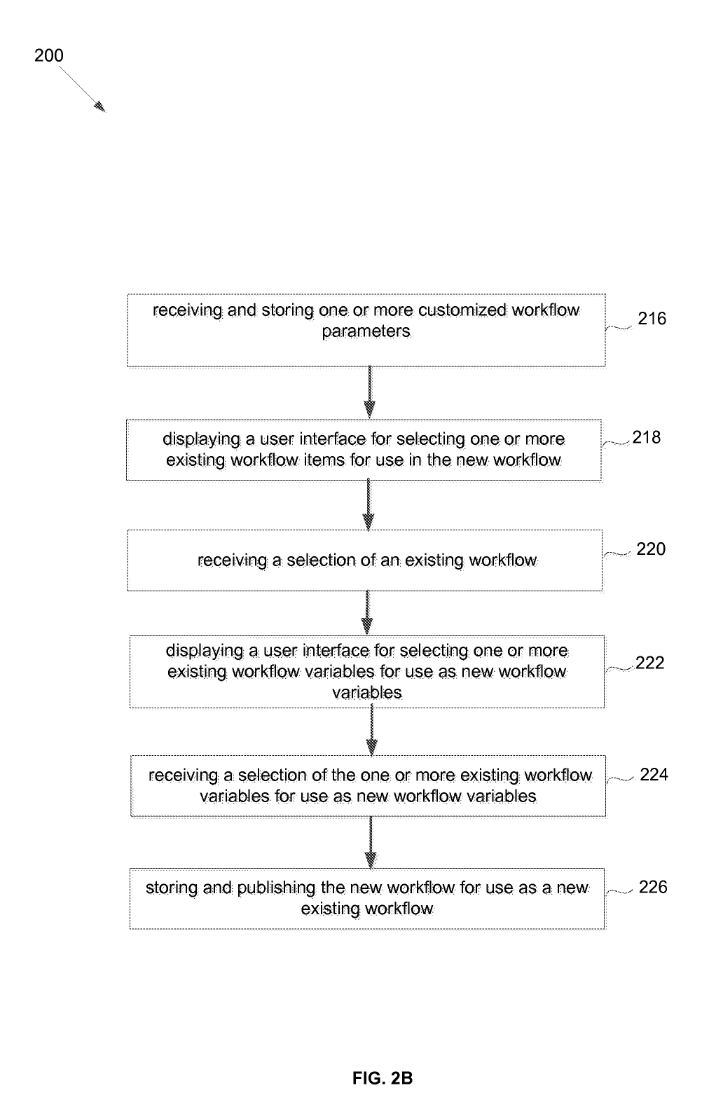

FIGS. 2a-2b are a flowcharts of a method for creating one or more new workflows using one or more existing workflow components according to an embodiment. In one embodiment, method 200 may include displaying 202 one or more collections of existing workflows available for selection. In embodiments, this may be accomplished storing the existing workflow in a shared application platform and by recognizing an association between at least one collection of workflows and the existing workflow. With reference to FIG. 1, one or more components of a reusable existing workflow (hereinafter referred to as an “existing workflow 118”) may be accessed when designing a new workflow 116 using a to the workflow design tool 102. This may be particularly advantageous when a workflow designer is aware of similar, related, or previous versions of a new workflow design the designer has been tasked to build. The designer of the new workflow may want to reuse one or more components of an existing workflow 118 for at least a portion of the new workflow 116. For example, an SAP consultant may be hired by a financial institution to implement a solution to resolve exceptions in their financial processes. The financial institution may have one or more systems defining rules for transactions that comply with the institution's transaction policies. Transaction rules may have exceptions that are evaluated on a case by case basis. The financial institution uses a shared application platform to help finance managers collaborate and manage their work, including managing exceptions that are generated by the SAP system, and uses one or more workflows to manage the exception approval process. Using a workflow design tool according to the present embodiments, the SAP consultant may be able to access one or more existing approval workflows when building new workflows relating to approving exceptions.

According to embodiments of the disclosure, an existing workflow 118 to be may have been created using any version of any workflow design tool, for instance workflow design tool 112 of FIG. 1, or any version of a workflow specific design tool. To enable reusability of one or more existing workflow components, existing workflow 118 may be published, for example to the shared application platform 104, to the application management service 106, or both. If an existing workflow 118 is published only to the application management service 106, existing workflow information may be transferred to a shared application platform 104 by providing a transmission bridge 124 connecting the two. Transmission bridge 124 provides interoperability between the shared application platform 104 and the application management service 106. Specifically, the transmission bridge 124 provides seamless transmissions of existing workflow data 108 between the shared application platform 104 and the application management service 104, and provides workflow designers with the ability to reuse workflows saved in the shared application platform 104 or the application management service 106. For instance, if existing workflow data 108 is stored in the application management service 106, transmission bridge 124 provides a message exchange, wherein an activity of a new workflow 116 may utilize a messaging layer of the application management service 106 to obtain existing workflow data 108 relating to the activity. In one instance, transmission bridge 124 provides a 1:1 instance mapping between the application management service 106 and the shared application platform 104 to avoid correlation complexity. If the existing workflow 118 is published only to the shared application platform 104, transmission bridge 124 may provide delegation instructions to delegate at least a portion of the workflow reusability process to the shared application platform 104. Transmission bridge 124 also provides two-way communication between the shared application platform 104 and application management service 106 to enable, for example, the shared application platform 104 to communicate a transmission status to the application management service 106 after receiving existing workflow data 108 or delegation instructions. Shared application platform 104 and application management service 106 may be operably connected, as shown in FIG. 1, or may be integrated, for example, into one enterprise platform.

Existing workflow component reusability provides a componentized solution for new workflow creation. Specifically, present embodiments remove the complexity of creating new workflows that span a shared application platform 104 and an application management service 106 hosting an existing workflow 118. For instance, rather than cutting and pasting code from an existing workflow 118 stored in the shared application platform 104 into a new workflow design created using a related or unrelated workflow design tool, present embodiments allow a new workflow designer to call the existing workflow 118 from within the new workflow 116 and receive results to be used in subsequent stages and actions in the new workflow 116. The resulting workflow can be customized, componentized and/or utilized separately from the existing workflow. To this end, new workflow designers may not have to write any service gateways, solve distributed security models, or solve any cross-product or cross-version integration challenges. Transmission bridge 124 also replaces the requirement for providing 100% parity and migration of information from one workflow design tool to another. Among other advantages, this approach permits changes to existing workflows to be automatically propagated to other workflows that call such existing workflows so that the code for such workflows need not be updated in multiple places). Moreover, calling existing workflows allows for workflows previously created in legacy or disparate workflow design tool or workflow languages to be used seamlessly. Such cross-compatibility enables a workflow designer to build workflows that include the capabilities of the designer's current workflow design tool and a different workflow design tool that may have been used to create any previous existing workflows.

As stated above, method 200 may recognize an association between at least one collection of workflows and an existing workflow. Specifically, providing an existing workflow available for use as a reusable workflow may include recognizing an association between an existing workflow and at least one workflow list or workflow site 110, 112, 114 stored, for example, on the shared application platform 104, or on at least one site where workflows are stored. A list workflow may refer to a workflow that runs on one or more specified items (discussed below). A site workflow may refer to a workflow that applies to a site in its entirety, and not just a list on the site (both a list and site workflow are hereinafter referred to as a “list workflow”). Shared application platform 104 may maintain at least one workflow list 110, 112, 114 associatable with an existing workflow 118. A workflow list 110, 112, 114 may be a collection of available workflows relating to a topic, project, event, a custom group, or other category of information. After a workflow is created, the workflow may be grouped with one or more other existing workflows by adding the workflow to the group's list. Workflows may be grouped according to any category, including one or more custom categories, and any number of workflows may be added to any number of lists. Workflow design tool 102 may also include a platform for creating a workflow list and storing the workflow list on the shared application platform 104. A workflow list 110, 112, 114 may be accessed via any shared application platform or design tool in communication with the shared application platform once the existing workflow has been associated with a list. An existing workflow 118 may be added to any number of workflow lists.

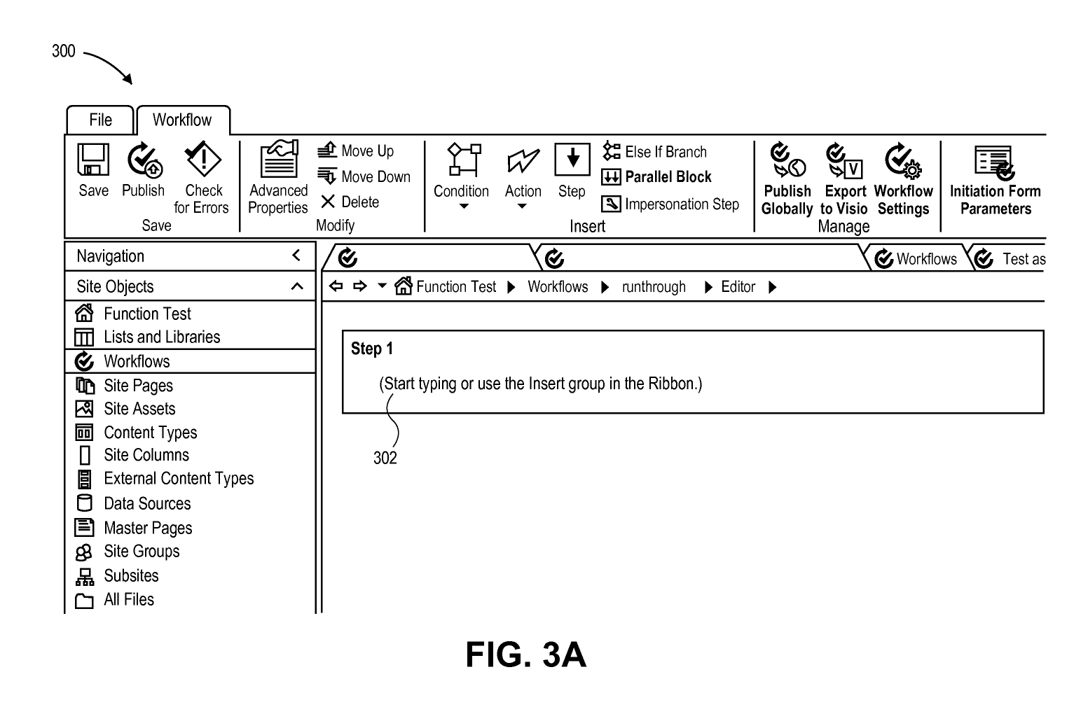

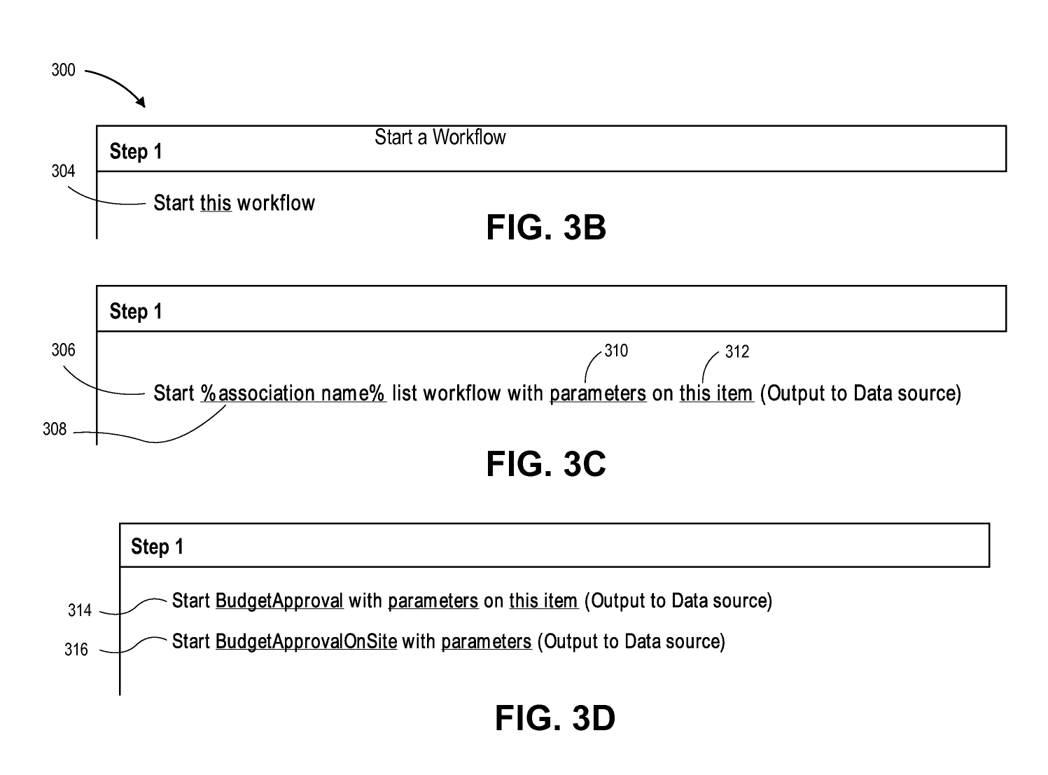

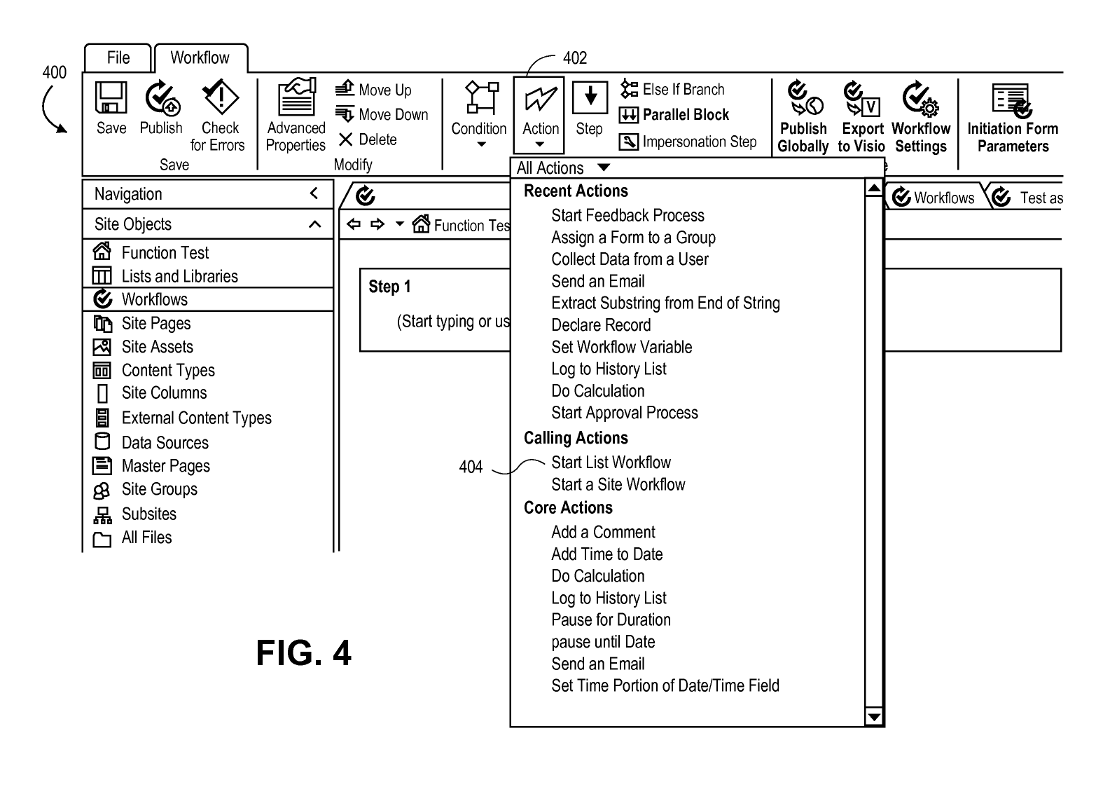

Method 200 may include 204 receiving 204 a selection of one of the one or more existing workflow collections. As used herein, “beginning a new workflow” shall also comprise editing a previously designed workflow. Workflow design tool 102 may include an initial user interface for starting the new workflow design process. FIGS. 3a-3d illustrate examples of an initial user interface 300 for designing a new workflow using one or more existing workflow components according to one embodiment of the disclosure. FIGS. 3a-3d, represent one embodiment of an initial user interface 300 provided by a workflow design tool 102. Alternative new workflow design interfaces that provide an alternative new workflow starting point may be utilized. Initial user interface 300 may receive one or more initial action selections from a user. For instance, workflow design tool 102 may enable a user to begin the workflow design process by prompting the user to enter a workflow command sentence (e.g., the “Start typing or use insert group in the Ribbon” 302 prompt of FIG. 3a). Command sentence may be any action sentence for starting a new workflow such as “Start this workflow” 304 of FIG. 3b. Alternatively, as shown in FIG. 4 workflow design tool 102 may provide a selectable “Action” tab 402 for starting a new workflow. Actions tab selection may result in the display of drop-down menu, pop-out dialog box, or any alternate means for providing a user selectable “start a new workflow” command (e.g., “Start List Workflow” 404). In other embodiments, one or more initial action sentences (e.g., FIG. 3B) may be presented to a user in the initial user interface 300 of the workflow design tool 102 when the “Start List Workflow” action is initiated via user interface 400 in FIG. 4.

Workflow command sentence may include one or more selectable action portions. Upon receiving an initial action to begin a new workflow, (e.g., by typing a command sentence, selecting an action from a drop down menu, etc.) a workflow command sentence may appear, for example, in the form “Start this workflow” 302 as shown in FIG. 3B. A further specific example is shown in FIG. 3C, where a user may be presented with a “Start % association name % list workflow with parameters on this item (Output to Data Source)” action sentence 306. To further define the action sentence, each underlined portion (e.g., “this” of FIG. 3B, or the % association name % 308 of FIG. 3C) of the action sentence may be a selectable action that, when selected, causes a user interface for customizing the selectable portion to display. One or more customizable portions of the action sentence that may be presented to a user include the workflow portion as discussed, one or more parameters and, optionally, one or more items that may be selected on which the new workflow may run. Parameter and item segment selection may occur after an existing workflow has been selected, and will be discussed further below. In addition, the sentence-based user interface(s) of FIGS. 3B, 3C, and 3D, may be automatically transformed based on the specific choices received at each stage (e.g., the link to a chosen workflow is automatically included in the sentence-based interface after being selected via a dropdown menu in a different interface).

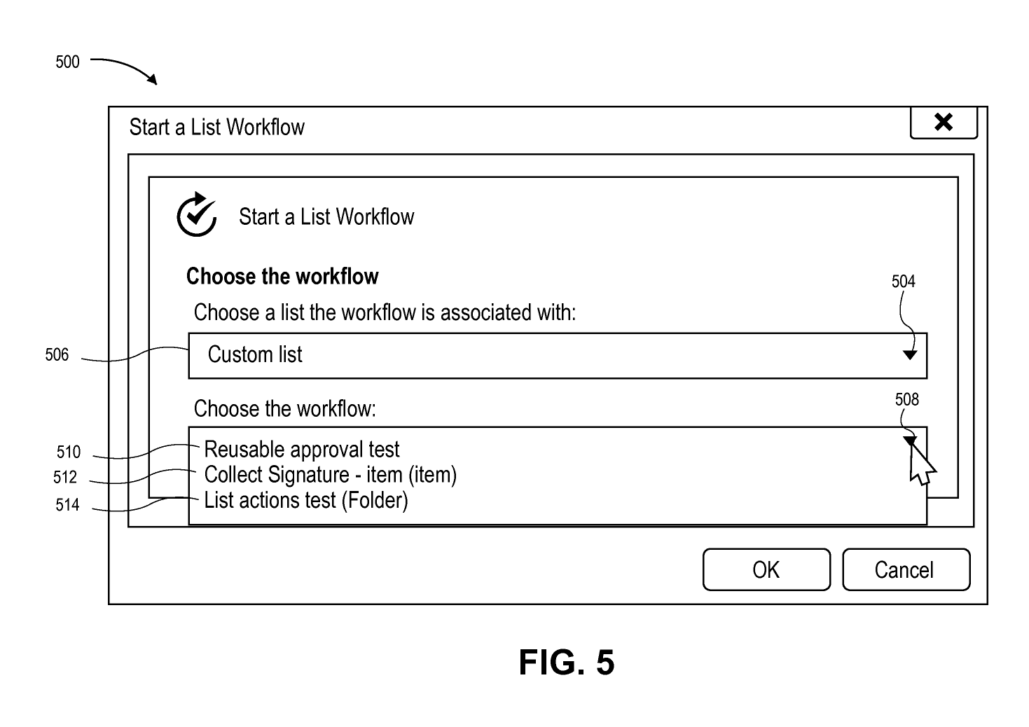

Method 200 may include displaying 206 one or more existing workflows associated with the selected existing workflow collection and receiving 208 a selection of one of the existing workflows in the selected existing workflow collection. For instance, upon a user selecting the “this workflow” portion of the workflow command sentence 304, or selecting “Start List Workflow” in the actions tab 402 of the initial user interface 300, one or more existing workflow lists (e.g., 110, 112, 114 of FIG. 1) may be displayed for selection in a workflow list user interface. FIG. 5 illustrates a workflow list user interface 500 for selecting a workflow and a workflow list 110, 112, 114. The workflow design tool 102 may access the shared application platform 104 where one or more workflows and one or more lists 110, 112, 114 are stored and provide the one or more workflow lists 110, 112, 114 to a user of the shared application platform for selection. If necessary, the shared application platform 104 may receive existing workflow data 118 from the application management service 106 via the transmission bridge 124. In one embodiment, workflow lists may be displayed in a drop-down menu 504 of the workflow list user interface 500. Workflow list user interface 500 may then receive a user list selection (e.g., Custom list 506 selection of FIG. 5).

Method 200 may include receiving 210 a selection of a variable in the selected existing workflow to be used in the new workflow and storing 212 the new workflow such that, when executed, the new workflow utilizes the selected variable from the existing workflow. Upon receiving a user selection of a workflow list, workflow design tool 102 may then guide a user to select a specific existing workflow from one or more available workflows associated with the selected list. Workflow list user interface 500 may further include one or more interfaces (e.g., drop-down menu 508) for selecting an existing workflow associated with the selected list (e.g., “Custom List” 506). In FIG. 5, examples of existing workflows associated with a list include a “Reusable approval test” workflow 510, a “Collect Signature—item (item)” workflow 512, and a “List actions test (Folder)” workflow 514.

Method 200 may then display 214 a user interface to customize one or more parameters of the existing workflow for use in the new workflow. In FIG. 3d, a specific example of how the user interface 300 may appear after a workflow has been selected is shown. For instance, a “Start BudgetApproval with parameters on this item (Output to Data source)” 314 is shown, wherein the BudgetApproval is the selected workflow, and “Start BudgetApprovalOnSite with parameters (Output to Data source)” 316 is shown to further illustrate adding an action of selecting an existing workflow 118 via the workflow design tool 102. Parameter information may be displayed either upon selection of a workflow in the workflow list user interface 500, or selection of the “parameters” action in the initial user interface 300. Existing workflow parameter information may then be retrieved from the shared application platform 104 (or the application management service 106) and presented to user. Existing workflow parameter information, among other things, identifies parameters (and information about those parameters) that are used as inputs into the selected existing workflow. In some instances, an existing workflow does not include input parameters. In such instances, new workflow creation interface will indicate that the existing workflow does not require input parameter setting.

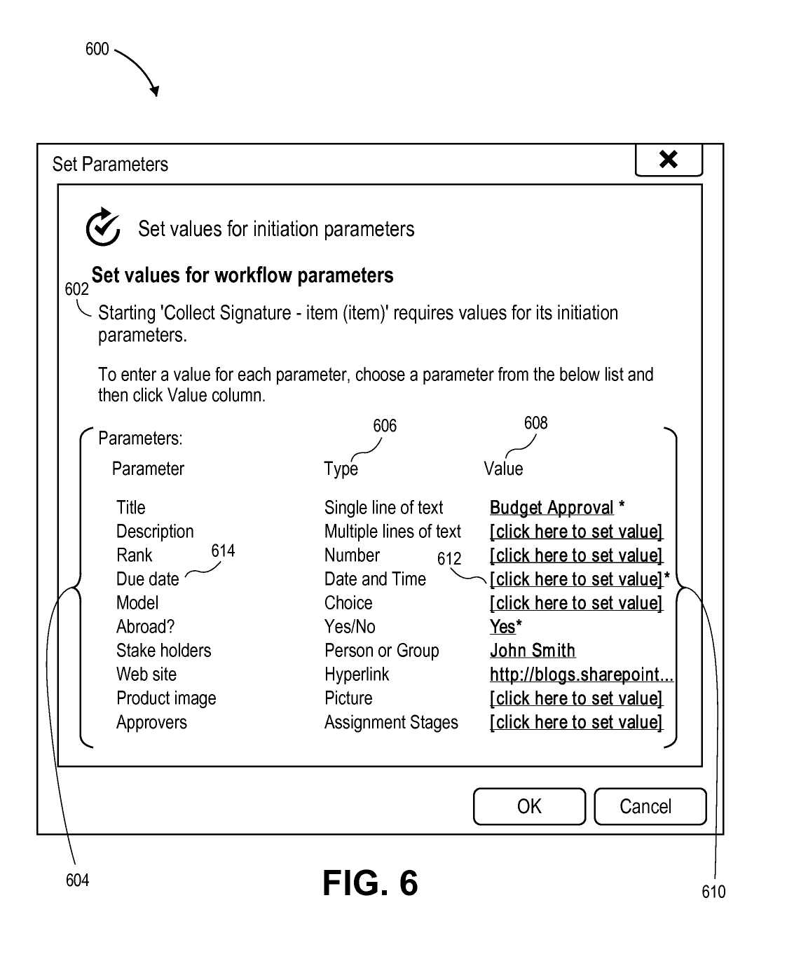

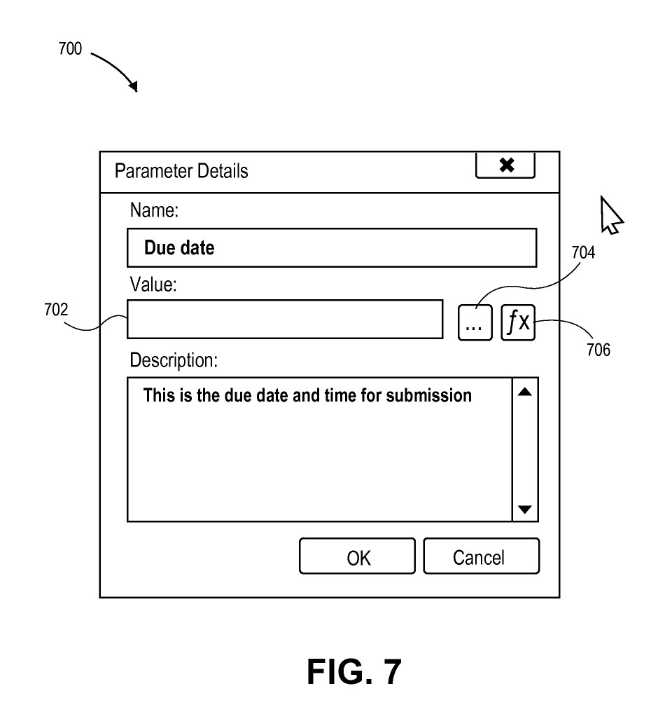

FIG. 6 illustrates a user interface 600 for customizing existing workflow parameters for use by the new workflow according to one embodiment. In the example provided in FIGS. 5 and 6, a workflow design tool may first receive the user existing workflow selection of “Collect Signature—item (item)” 512, and a set parameters user interface 600 may be displayed. Set parameters interface 600 may display one or more parameters 604 of the existing workflow 118. In embodiments, this parameter information is requested for the selected workflow by the workflow design tool 102 from the shared application platform 104 (e.g., from the existing workflow data 108 stored on shared application platform 104). One or more existing workflow parameters 604 may be selected for use by the new workflow in initiating the existing workflow that is to be called by the new workflow. Set parameter user interface 600 may display a message such as “starting ‘Collect Signature—item (item)’ requires values for its initiation parameters” 602. Set parameters user interface 600 may display a plurality of existing workflow parameters 604 and any corresponding information, such as parameter type 606 and parameter value 608. In one embodiment, set parameters user interface 600 may provide a customizable variable value section 610 for customizing a variable of one or more displayed parameters 602. Upon receiving a user selection of the value field for one of the parameters (e.g., “[click here to set value]” 612 of the “Due date” parameter 614) in the customizable parameter value section 610, a parameter details user interface may appear to enable a user to set a value for the selected parameter. FIG. 7 illustrates a parameter details user interface 700. For instance, when the user selects the “Due date” 614 parameter, parameter details user interface 700 may display and may include an enterable field for entering a due date value 702. This parameter value is then stored and passed to the existing workflow when called by the new workflow. An optional automatic field populator 704 may also be displayed to allow a user to select a value rather than type in a value.

Variable values may also be available via a parameter variable value lookup. For example, a function icon 706 may be provided to execute a look up for one or more existing workflow parameter variable values. For instance, the due date set in the existing workflow 118 may be looked up for use as the due date in the new workflow 116. A user may select the function icon 706 in the set parameter user interface 700 and a lookup (e.g., a pop-out dialog box) may be displayed with values retrieved from existing workflow data 108. Through the user interface 600 displayed 214 for customizing parameter values for the existing workflow, such values are received 216 and stored so that they may be passed to the existing workflow 118 when the new workflow 116 is executed. Workflow design tool 102 may display an error message if a required parameter does not include a variable value. However, not all available existing workflow parameters may need to be selected and/or customized.

Continuing in FIG. 2B, method 200 may include displaying 218 a user interface for selecting one or more existing workflow items on which the new workflow may run. Selection of such existing workflow items may be received 220 through such user interface. One or more new workflow items may also be set from the initial workflow user interface 300. For instance, workflow design tool may be used to configure the initial workflow command sentence to include the ability to select one or more existing workflow items (e.g., the “Start % association name % list workflow with parameters on this item (Output to Data Source)” of FIG. 3b (emphasis added)). In one embodiment, the workflow design tool 102 may receive a user activation to initiate selection one or more existing workflow items. For instance, a user may activate the “item” 312 segment of workflow command sentence 306, as in FIG. 3c. Alternatively, existing workflow item selection may be available at any point during the formatting of the new workflow.

As provided in embodiments herein, variables from an existing workflow can be selected as variables for the new workflow. Once the selections are received, the workflow design tool 102 may store the selected data source, field, and format as part of the new workflow. Upon execution of the new workflow, the variable information from the selected data source and field is returned to the new workflow in the selected format. In one embodiment, the corresponding values of any selected and customized parameters of the existing workflow may be stored in the shared application platform 104 and read by the new workflow at runtime, or may be passed to the new workflow at runtime. Any existing workflow variable or data source field value may be used to set any parameter of the new workflow.

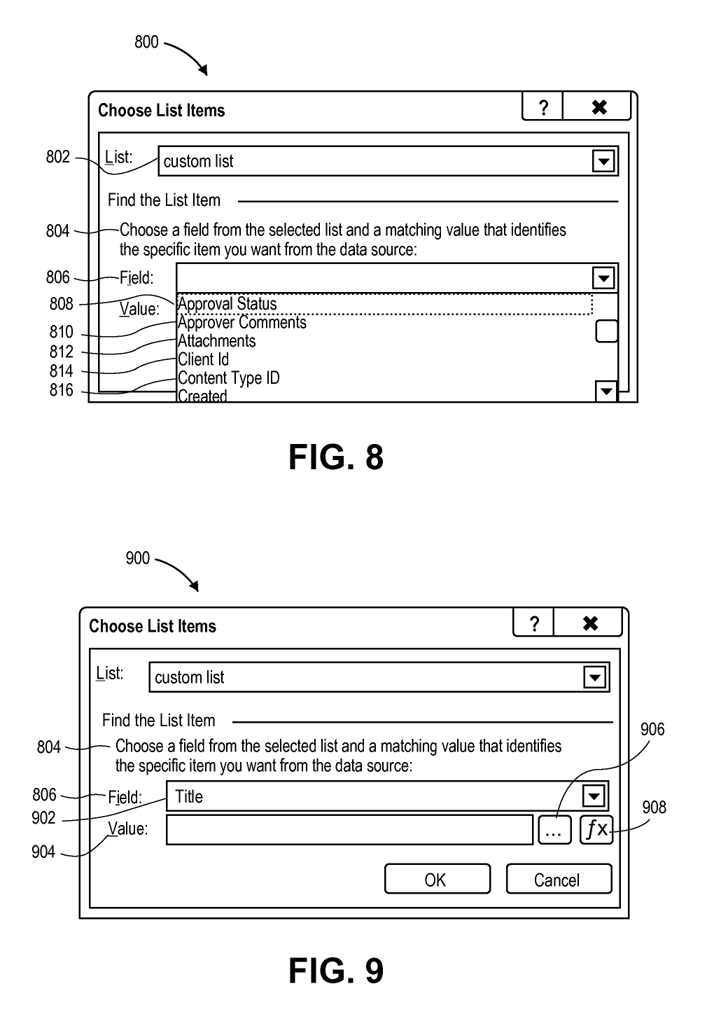

FIGS. 8 and 9 illustrate a set item user interfaces 800 and 900 for a “list” type of existing workflow. One or more workflow items may be discovered upon selection of a workflow list (e.g., from a workflow list, such as “custom list” 802 of FIG. 8). Set item user interface 800 may provide a prompt 804 for a user to choose a field name and a matching value that identifies the specific desired item on which the existing workflow will run. As can be seen in FIG. 8, selectable existing workflow field names may include field names for approving a workflow segment (e.g., ApprovalStatus 808), adding comments to a workflow segment (e.g., Approver Comments 810), providing a link to attachments (e.g., an Attachments item 812), client identifier information (e.g., Client ID item 814), content type (e.g., Content Type ID item 816), etc. As shown in FIG. 9, a “Title” field name 902 may be selected. A value 904 for the selected field name may then be selected. A user may enter an item name or value, or an optional automatic item value populator 906 may also be displayed to allow a user to select a value rather than type in a value.

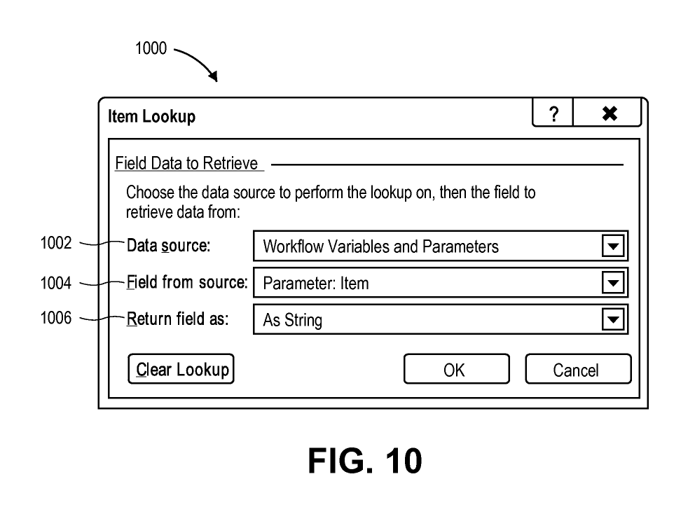

A user interface may be displayed 222 for selection of new workflow items. As with selecting the one or more existing workflow parameters, one or more selectable items may be available via a lookup. Lookup may be utilized to look up any stored workflow or platform data and use the data to determine where the existing workflow will run, and provide this data for use in the new workflow. As shown in FIG. 9, a function icon 908 may be provided to execute a look up to determine, for example, one or more items on which the existing workflow will run. User may select function icon 908 and a lookup (e.g., a pop-out menu) may be displayed. FIG. 10 illustrates an example lookup interface 1000 that may be utilized, for instance, to select one or more items on which the new workflow will run. For instance, a data source prompt 1002 may be provided to guide a user to select a data source (e.g., a category of available item sources, such as “Workflow Variables and Parameters” as shown in FIG. 10). A user may then be guided to select a field name 1004 (e.g., a “Parameter:Item” field as shown in FIG. 10). A user may determine the format 1006 in which one or more discovered items corresponding with the selected field name may be returned (e.g., the “As String” as shown in FIG. 10). Once the selections are received 224, the workflow design tool 102 may store the selected data source, field name, and item as the item on which the new workflow will run. Upon execution of the new workflow on the item, the variable information from the selected data source may be returned to the new workflow in the selected format.

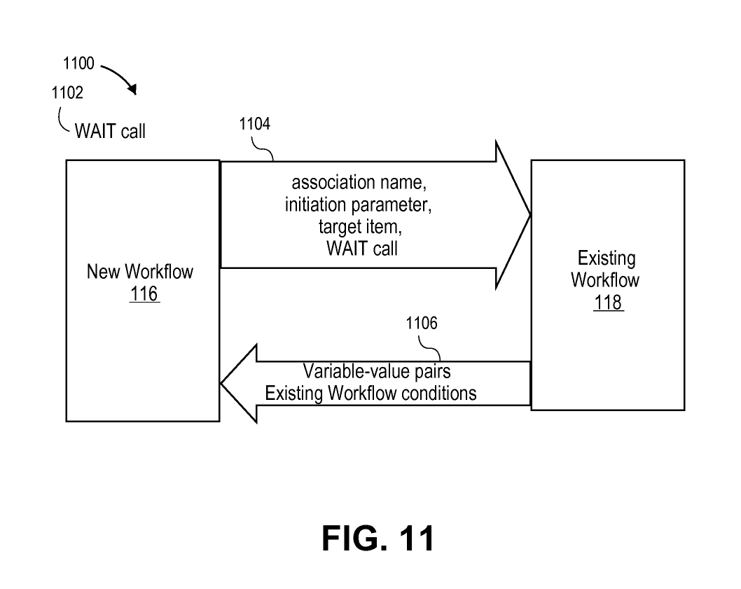

When desired parameters have been set and an item has been optionally selected, a new workflow may be ready for execution. At runtime, new workflow 116 may call a workflow list 112, 114, 116 or an existing workflow 118 to obtain new workflow parameter and variable values and, in some instances, one or more existing workflow conditions (e.g., values that convey, for example, exit status, elapsed time, and/or event completion type of existing workflow 118). FIG. 11 is a process diagram illustrating the runtime of a new workflow 116 according to one embodiment. As shown in FIG. 11, a new workflow 116 may call a workflow list 112, 114, 116 or an existing workflow 118 to obtain new workflow data 1104 such as a list association name for the new workflow, a parameter value, or an item. Workflow design tool 102 may pass one or more parameters, one or more variable pairs and/or conditions 1106 from the list 112, 114, 116 or the existing workflow 118 to the new workflow 116. To ensure proper transfer of workflow data 108, workflow design tool 102 may provide a “wait call” option for the new workflow. In a “wait” call, as shown in FIG. 11, workflow design tool 102 may wait and return the one or more called workflow variable value pairs and/or conditions 1106 to the new workflow 116 only after the execution of the existing workflow 118.

Method 200 may include storing and publishing 226 the new workflow for use as a new existing workflow. New workflow may be published on the shared application platform 104 or on the application management service 106, and may be executed in any shared application platform. New workflow data 120 may also be stored in the shared application platform 104 or in the application management service 106. New workflow may be associated with a list, and the new workflow, along with any of any items on which the new workflow will execute and variables may be available for use by any subsequent workflow, via one or more of the process described herein.

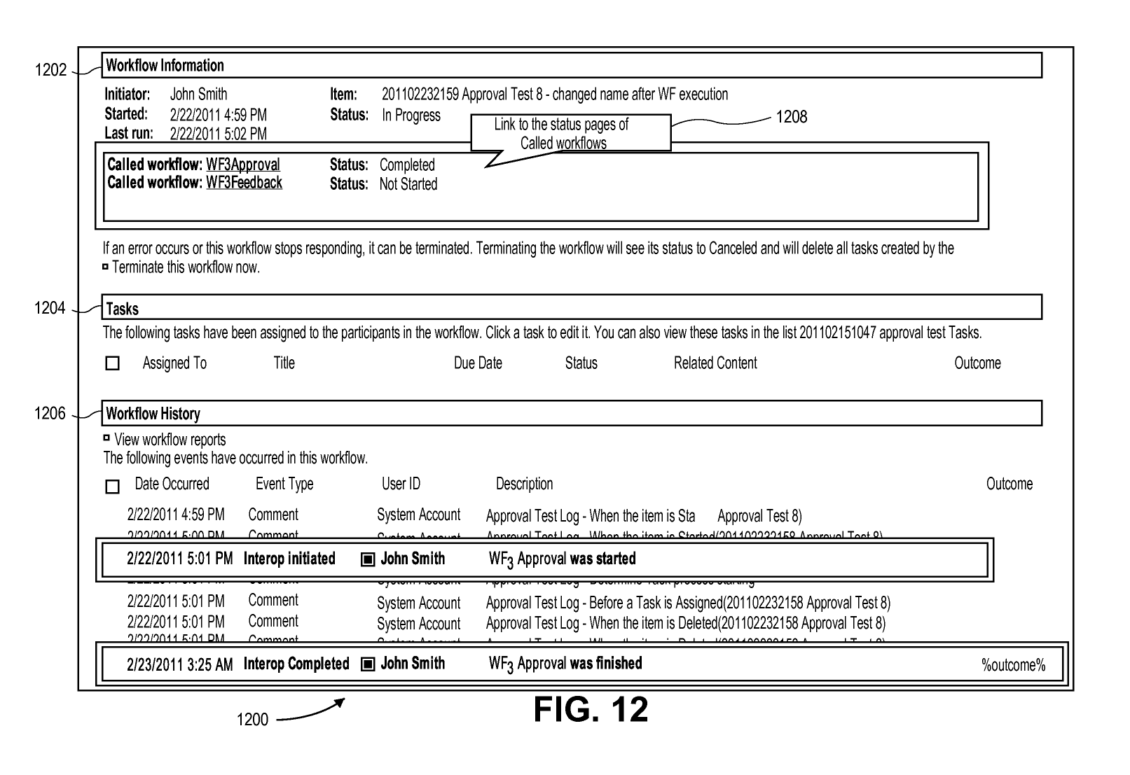

FIG. 12 illustrates workflow process monitoring 1200 according to one embodiment. Workflow progress may be monitored on workflow status page consisting of at least Workflow Information 1202, Tasks 1204, and Workflow History list 1206. Workflow History 1206 may log one or more design or run-time errors perceivable on the server. For a workflow with one or more “Start a workflow” processes running, additional workflow information may be provided. The existing workflow status page may be linked to a new workflow status page. For instance, a link to a status page(s) 1208 of existing workflow may be inserted inside Workflow Information 1202. Error detection and/or display of any errors occurring prior to run-time (e.g., during the creation), at run-time of the new workflow, or after run-time of the new workflow may be accomplished by accessing the new workflow status page via the link. For instance, a called existing workflow may also be terminated from the new workflow status page. The link may be written as the association name of the workflow. A status of the existing workflow may also be displayed, for instance, adjacent to the link. A user may verify a new workflow status and verify one or more variable values. For instance, a user may verify the status of a new workflow and one or more values of variables by logging them or writing the status and/or variable value to a web page. Workflow design tool 102 (or a workflow execution tool, if different) may also present this function to the users or the new workflow by returning status fields for monitoring existing workflow conditions and all variable values at the end of an existing workflow execution.

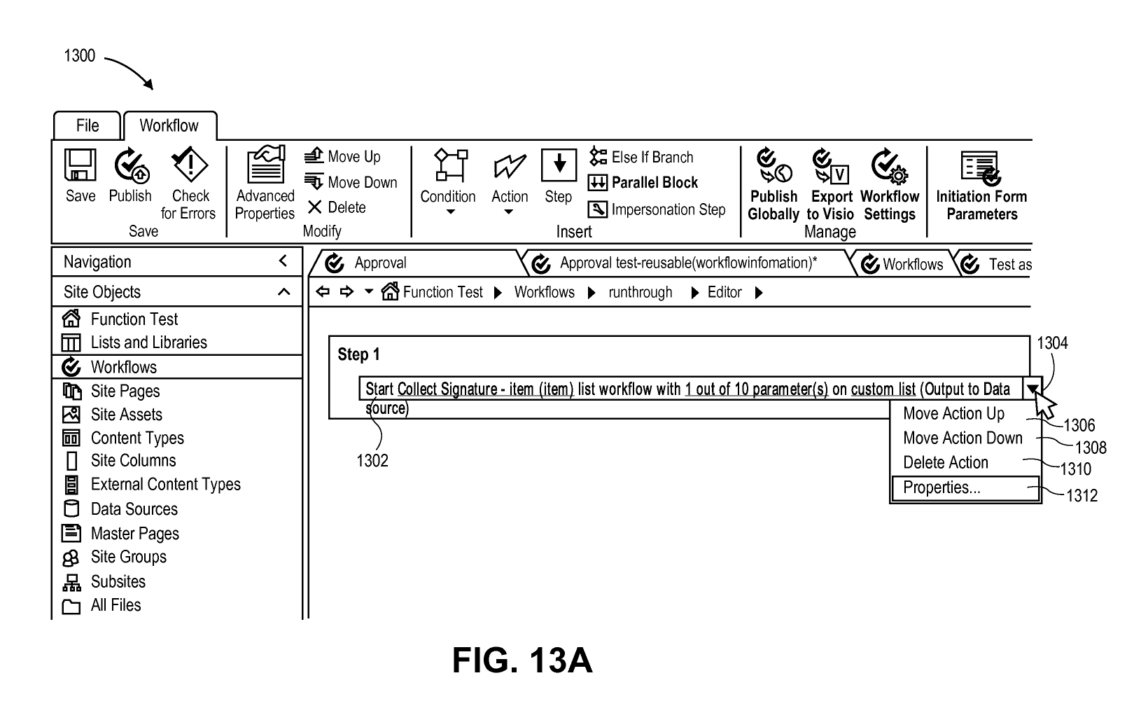

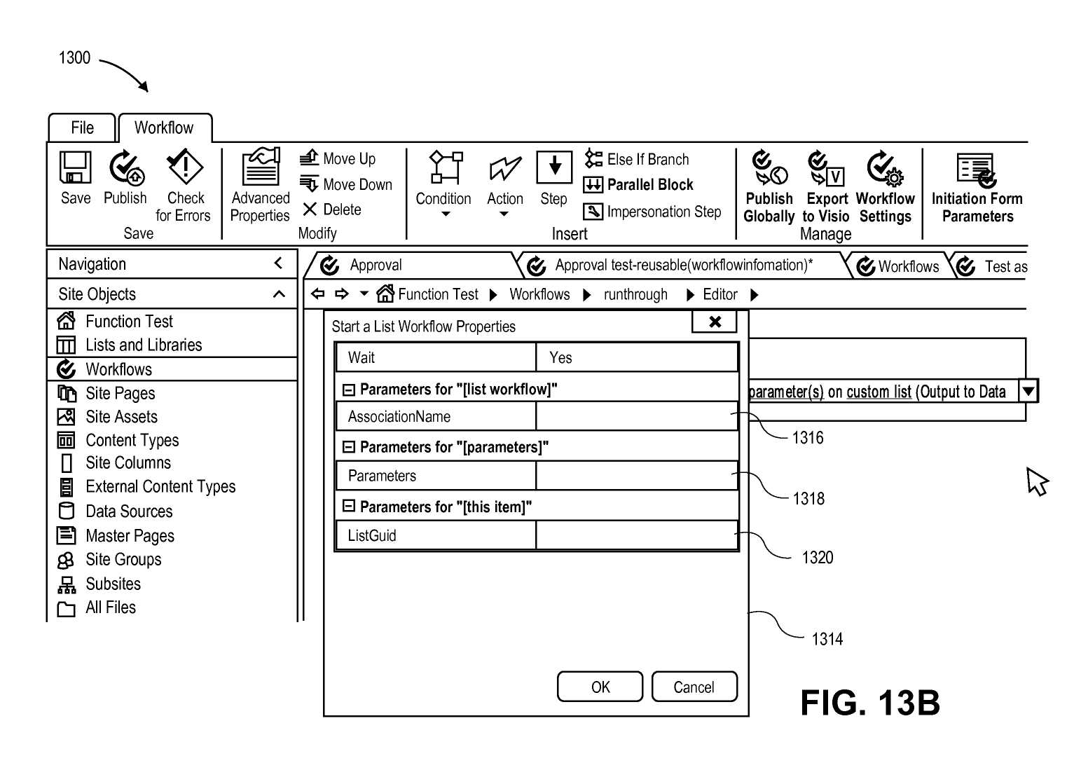

FIGS. 13A-13B illustrate a property pain 1300 according to one embodiment. One or more workflow properties may be selectable from an action sentence 1302. Specifically, an action sentence 1302 may provide a drop-down menu 1304 displaying one or more options for the action sentence (e.g., “Move Action Up” 1306, “Move Action Down” 1308, “Delete Action” 1310, and “Properties” 1312). From the drop-down menu, Properties 1312 may be selected and a properties dialog 1314 may appear (as shown in FIG. 13B. Properties dialog may display one or more workflow properties (e.g., “Parameters for ‘[list workflow]’” 1316, referring to the selected list workflow, “Parameters for [parameters]”” 1318, referring to the selected parameter, and “Parameters for ‘[this item]’” 1320, referring to the selected item).

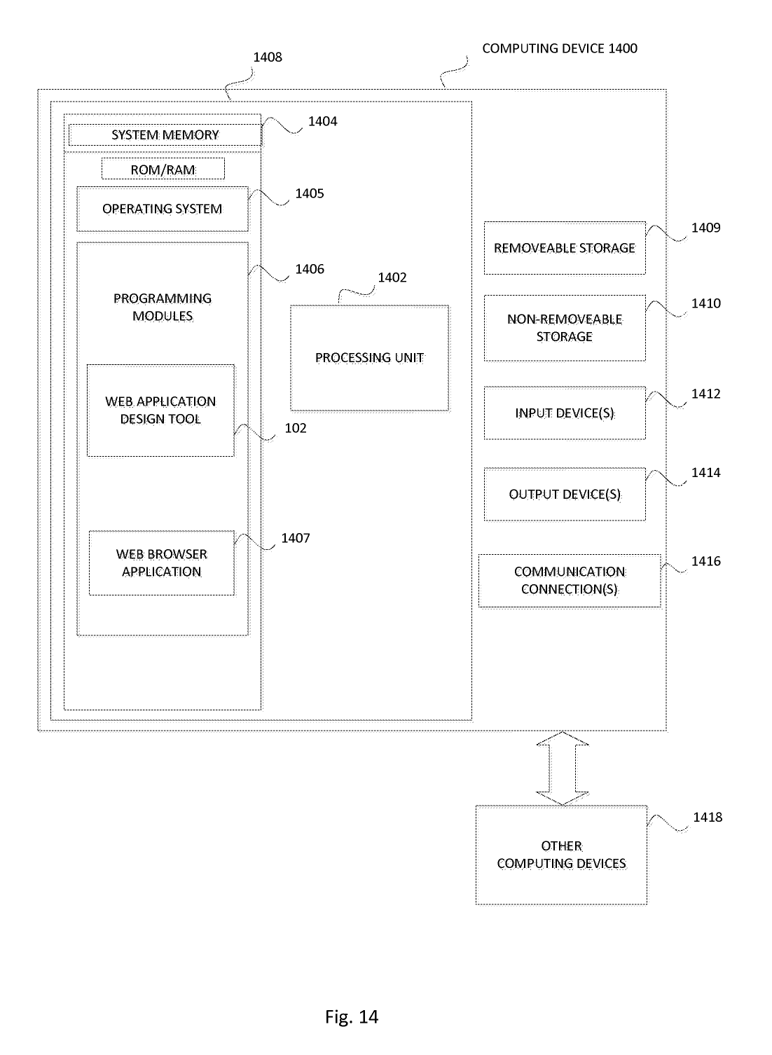

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIG. 14 and its associated description provide a discussion of a variety of operating environments in which embodiments may be practiced. However, the devices and systems illustrated and discussed with respect to FIG. 14 are for purposes of example and illustration and are not limiting of a vast number of computing device configurations that may be utilized for practicing embodiments, described herein.

FIG. 14 is a block diagram illustrating example physical components of a computing device 1400 with which embodiments may be practiced. In a basic configuration, computing device 1400 may include at least one processing unit 1402 and a system memory 1404. Depending on the configuration and type of computing device, system memory 1404 may comprise, but is not limited to, volatile (e.g. random access memory (RAM)), non-volatile (e.g. read-only memory (ROM)), flash memory, or any combination. System memory 1404 may include operating system 1405, one or more programming modules 1406, and may include the workflow design tool 102 for providing project workflow creation and editing. Operating system 1405, for example, may be suitable for controlling the operation of computing device 1400. Furthermore, embodiments may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410.

As stated above, a number of program modules and data files may be stored in system memory 1404, including operating system 1405. While executing on processing unit 1402, programming modules 1406, such as the workflow design tool 102, may perform processes including, for example, one or more of the processes described above with reference to FIGS. 1-13. The aforementioned processes are an example, and processing unit 1402 may perform other processes. Other programming modules that may be used in accordance with embodiments may include electronic mail and contacts applications, word processing applications, spreadsheet applications, database applications, slide presentation applications, drawing or computer-aided application programs, etc.

Generally, consistent with embodiments, program modules may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Furthermore, embodiments may be practiced in an electrical circuit comprising discrete electronic elements, packaged or integrated electronic chips containing logic gates, a circuit utilizing a microprocessor, or on a single chip containing electronic elements or microprocessors. For example, embodiments may be practiced via a system-on-a-chip (SOC) where each or many of the components illustrated in FIG. 14 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the workflow design tool 102 may be operated via application-specific logic integrated with other components of the computing device/system 1400 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Embodiments, for example, may be implemented as a computer process (method), a computing system, or as an article of manufacture, such as a computer program product or computer-readable storage medium. The computer program product may be a computer-readable storage medium readable by a computer system and encoding a computer program of instructions for executing a computer process.

The term computer-readable storage medium as used herein may include computer storage media. Computer storage media may include volatile and nonvolatile, removable and non-removable media implemented in any method or technology for storage of information, such as computer-readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, etc. Output device(s) such as a display, speakers, a printer, etc. may also be included. The aforementioned devices are examples and others may be used.

Communication media may be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments herein may be used in connection with mobile computing devices alone or in combination with any number of computer systems, such as in desktop environments, laptop or notebook computer systems, multiprocessor systems, micro-processor based or programmable consumer electronics, network PCs, mini computers, main frame computers and the like. Embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments.

Embodiments, for example, are described above with reference to block diagrams and/or operational illustrations of methods, systems, and computer program products according to embodiments. The functions/acts noted in the blocks may occur out of the order as shown in any flowchart or described herein with reference to FIGS. 1-12. For example, two processes shown or described in succession may in fact be executed substantially concurrently or the blocks may sometimes be executed in the reverse order, depending upon the functionality/acts involved.

While certain embodiments have been described, other embodiments may exist. Furthermore, although embodiments have been described as being associated with data stored in memory and other storage mediums, data can also be stored on or read from other types of computer-readable storage media, such as secondary storage devices, like hard disks, floppy disks, a CD-ROM, or other forms of RAM or ROM. Further, the disclosed processes may be modified in any manner, including by reordering and/or inserting or deleting a step or process, without departing from the embodiments.

It will be apparent to those skilled in the art that various modifications or variations may be made to embodiments without departing from the scope or spirit. Other embodiments are apparent to those skilled in the art from consideration of the specification and practice of the embodiments disclosed herein.

1. A method for providing a new workflow that calls an existing workflow or workflow list comprising:
displaying on a display device one or more collections of existing workflows available for selection;
receiving a selection of one of the one or more existing workflow collections;
displaying one or more existing workflows associated with the selected existing workflow collection;
receiving a selection of one of the existing workflows in the selected existing workflow collection;
receiving a selection of a variable in the selected existing workflow to be used in the new workflow; and
storing the new workflow such that, when executed, the new workflow utilizes the selected variable from the existing workflow.

2. The method of claim 1, wherein the displaying one or more existing workflows comprises recognizing an association between the selected existing workflow collection and the displayed existing workflows.

3. The method of claim 1, further comprising:
determining whether a set of parameters exist for the selected existing workflow;
if applicable, displaying the set of parameters;
receiving at least one value for the set of parameters; and
storing the at least one value for the set of parameters such that, upon execution of the new workflow, the at least one value is provided as an input to the selected existing workflow, wherein the at least one value includes at least one new workflow variable available as an input parameter of the existing workflow.

4. The method of claim 3, further including:
executing the new workflow, including providing the at least one value to the selected existing workflow.

5. The method of claim 4, further comprising:
displaying information about execution of the new workflow prior to, during, and after execution thereof; and
simultaneously displaying information about execution of the selected existing workflow.

6. The method of claim 5, further including:
displaying a set of items on which the selected existing workflow has run; and
receiving an existing workflow item selection allowing the new workflow to run on the selected item.

7. The method of claim 1, wherein the selected variable is a variable of the selected existing workflow.

8. The method of claim 7 further including:
publishing the new workflow; and
making the published new workflow available for use as a new existing workflow.

9. A system for providing a reusable workflow comprising:
a shared application platform storing one or more collections of existing workflows;
a workflow design tool executed by a processor and coupled to the shared application platform, the workflow design tool configured to:
display one or more collections of existing workflows available for selection;
receive a selection of one of the one or more existing workflow collections;
display one or more existing workflows associated with the selected existing workflow collection;
receive a selection of one of the existing workflows in the selected existing workflow collection;
receive a selection of a variable in the selected existing workflow to be used in the new workflow; and
store the new workflow such that, when executed, the new workflow utilizes the selected variable from the existing workflow.

10. The system of claim 9, wherein the shared application platform determines if a set of parameters exists for the selected existing workflow;
displays the set of parameters if applicable;
receives at least one value for the set of parameters; and
stores the at least one value for the set of parameters such that, upon execution of the new workflow, the at least one value is provided as an input to the selected existing workflow.

11. The system of claim 9, wherein the workflow design tool executes the new workflow, including providing the at least one value to the selected existing workflow.

12. The system of claim 9, wherein the workflow design tool displays information about execution of the new workflow prior to, during, and after execution thereof; and
simultaneously displays information about execution of the selected existing workflow.

13. The system of claim 12, wherein the workflow design tool includes an existing workflow item selection interface includes configured to display a set of items on which the selected existing workflow has run; and
receive an existing workflow item selection allowing the new workflow to run on the selected item.

14. The system of claim 9, wherein the selected variable is a variable from the selected existing workflow.

15. The system of claim 9 wherein the workflow design tool is configured to transfer the new workflow to an application management service for publishing and storing the new workflow and making the published new workflow available for use a new existing workflow.

16. A computer-readable storage medium comprising executable instructions that, when executed by a processor, provide one or more reusable workflows, the computer-readable medium including instructions executable by the processor for:
displaying one or more collections of existing workflows available for selection;
receiving a selection of one of the one or more existing workflow collections;
displaying one or more existing workflows associated with the selected existing workflow collection;
receiving a selection of one of the existing workflows in the selected existing workflow collection;
receiving a selection of a variable in the selected existing workflow to be used in the new workflow;
storing the new workflow such that, when executed, the new workflow utilizes the selected variable from the existing workflow;
determining a set of parameters for the selected existing workflow;
displaying the set of parameters;
receiving at least one value for the set of parameters; and
storing the at least one value for the set of parameters such that, upon execution of the new workflow, the at least one value is provided as an input to the selected existing workflow.

17. The computer-readable storage medium of claim 16, further including:
executing the new workflow, including providing the at least one value to the selected existing workflow.

18. The computer-readable storage medium of claim 16, further comprising:
displaying information about execution of the new workflow at least one of prior to, during, or after execution thereof; and
simultaneously displaying information about execution of the selected existing workflow.

19. The computer-readable storage medium of claim 18, further including:
displaying a set of items on which the selected existing workflow has run; and
receiving an existing workflow item selection allowing the new workflow to run on the selected item.

20. The computer-readable storage medium of claim 16, wherein the selected variable is a variable from the selected item of the selected existing workflow.
